(19) United States
(12) Patent Application Publication
(10) Pub. No.: US 2016/0075838 A1
(43) Pub. Date: Mar. 17, 2016

(54) Black Polytetrafluoroethylene Porous Film, Production Process for the Same, and Uses of the Same

(71) Applicant: NIPPON VALQUA INDUSTRIES, LTD., Tokyo (JP)

(72) Inventors: Naoki Watanabe, Machida city (JP); Yoshihiro Setoguchi, Machida city (JP); Youichirou Wada, Machida city (JP); Manabu Motoori, Machida city (JP)

(21) Appl. No.: 14/785,926

(22) PCT Filed: Apr. 24, 2014
(86) PCT No.: PCT/JP2014/061570

§ 371 Date: Oct. 21, 2015

(30) Foreign Application Priority Data
Apr. 26, 2013 (JP) 2013-093823

(51) Int. Cl. C08J 5/18; D01D 5/00; B01D 39/16; C08K 3/04

(52) U.S. Cl. CPC C08J 5/18; C08K 3/04; D01D 5/003; B01D 39/1623; C08J 2327/18; D10B 2321/042; D10B 2505/04

(57) ABSTRACT

Provided is a black PTFE porous film which comprises a black colorant-containing PTFE nanofiber (D) containing a polytetrafluoroethylene (PTFE) nanofiber (E) and a black colorant (B) and has a value (V), as represented by a Munsell symbol in accordance with JIS Z 8721, of not more than N2.5, wherein the black colorant-containing PTFE nanofiber (D) is obtained by subjecting a spinning solution containing at least PTFE or modified PTFE (A) to an electrospinning method.

### TECHNICAL FIELD

The present invention relates to a black polytetrafluoroethylene porous film, a production process for the same and uses of the same.

### BACKGROUND ART

Since polytetrafluoroethylene (PTFE) has excellent chemical resistance, heat resistance and electrical insulation properties and further has properties such as self-lubricating properties and non-adhesion properties, it has been widely used not only in the industrial field but also in the field of daily life.

For example, PTFE is used by being processed into a porous film, and the PTFE porous film is used for a filter such as a vent filter.

A vent filter is used for, for example, an acoustic microphone or a cover of a cellular phone or the like, ensures ventilation inside a molded product and imparts waterproof and dustproof functions to the molded product while retaining a pressure control function.

As PTFE used for a vent filter, PTFE obtained by subjecting unexpanded PTFE to expanding treatment and thereby making it porous (ePTFE) has been widely utilized at present.

However, the ePTFE is constituted of fibrous parts and knot parts of PTFE, and by virtue of this unique structural feature, the light with which the ePTFE has been irradiated is substantially totally reflected. Hence, the ePTFE has a characteristic of true white appearance, and therefore, it is not suitable for uses in which a white color is not permitted.

Particularly when the white ePTFE is used for a vent filter that is used in a cellular phone or the like, a serious problem occurs. For example, if a vent filter formed of white ePTFE is used in a black cellular phone, the white vent filter is very conspicuous in appearance. Therefore, the vent filter arouses user's curiosity, and for example, the user unnecessarily touches the vent filter or does inappropriate additional work, and as a result, a problem such that the life of the vent filter is shortened occurs.

Such a problem has been taken up also in a patent literature 1 (Japanese Patent Laid-Open Publication No. 1995-289865). In the patent literature 1, there has been taken up a problem of occurrence of an accident such that if a white vent filter formed of ePTFE is used in the case where a color other than a white color is required for a vent filter from the viewpoint of design of a product, it arouses user's curiosity and the user pushes the white vent filter with a sharp tip of a writing implement or the like to eliminate waterproof performance. The patent literature 1 teaches that such a problem is solved by a vent filter which uses, as a raw material, colored paste-like PTFE that is obtained by mixing a colorant, a PTFE fine powder and a liquid lubricating agent and which is formed of only an expanded porous PTFE film obtained from previously colored PTFE.

However, when the vent filter described in the patent literature 1 is intended to be colored black (in the present specification, “black” means that a value (V) represented by a Munsell symbol in accordance with JIS Z 8721 is not more than N2.5), coloring can be made only up to about a gray color (the above value (V) is at smallest about N3.2). For example, even if a porous PTFE film having a value of not more than 2.5 is intended to be prepared by increasing the amount of a black colorant, it becomes difficult to expand PTFE uniformly and at a high expansion ratio in the expanding step, so that the air permeability is low, and hence, a film suitable for a vent filter cannot be obtained. On that account, the color of the vent filter needs to be further brought closer to black (the above value needs to be made smaller than N2.5) without inducing lowering of properties.

Here, the invention described in the patent literature 1 is characterized in that colored paste-like PTFE obtained by mixing a colorant, a PTFE fiber powder and a liquid lubricating agent is used as a raw material of a vent filter, and this invention is characterized by the production process.

Then, as an invention to produce a PTFE molded product utilizing a process other than the process described in the patent literature 1, a patent literature 2 (Japanese Translation of PCT International Application Publication No. 2012-215850) is taken up here.

In the patent literature 2, a process for preparing a PTFE mat by an electrospinning method (so-called electrospinning method) is described. In the invention described in the patent literature 2, however, it is taken as a problem to provide a method for improving electrospinning of PTFE, and a problem concerning a color of the PTFE has not been recognized. Therefore, the patent literature 2 does not teach any means for solving the problem concerning a color of the PTFE.

In a patent literature 3 (WO 2009/031620), a water-soluble electrospun sheet containing a water-soluble base material is described, and as the water-soluble base material, a vinyl-based polymer, an acrylic polymer or the like is mentioned, and an embodiment in which the water-soluble electrospun sheet contains a coloring component is also described.

In a patent literature 4 (Japanese Patent Laid-Open Publication No. 2012-12339), a sheet-like cosmetic for make-up having a sheet of nanofibers of a polymer compound containing a color pigment is described, and a process for producing the sheet-like cosmetic for make-up by an electrospinning method is also described.

In the patent literature 3 and the patent literature 4, a method for coloring a polymer compound utilizing an electrospinning method is described, but there is no description of PTFE, and in the patent literature 3 and the patent literature 4, a problem that PTFE cannot be colored black has not been recognized. Therefore, the patent literature 3 and the patent literature 4 do not teach any means for solving a problem concerning a color of the PTFE. In the patent literature 3 and the patent literature 4, further, there is no description of uses of filters, such as a vent filter.

As described above, a black PTFE porous film having the above value (V) of not more than N2.5 has not been known in the past.

### CITATION LIST

### Patent Literature

Patent literature 1: Japanese Patent Laid-Open Publication No. 1995-289865

Patent literature 2: Japanese Translation of PCT International Application Publication No. JP-T-2012-215850

Patent literature 3: WO 2009/031620

Patent literature 4: Japanese Patent Laid-Open Publication No. 2012-12339

### SUMMARY OF INVENTION

### Technical Problem

It is an object of the present invention to provide a Black PTFE porous film which does not impair performance of a conventional PTFE porous film, such as strength, and has the above value (V) of not more than N2.5.

### Solution to Problem

In order to solve the above problem, the present inventors have earnestly studied, and as a result, they have found that the above problem is solved by a black PTFE porous film which comprises a black colorant-containing PTFE nanofiber (D) containing a polytetrafluoroethylene (PTFE) nanofiber (E) and a black colorant (B), and has a value (V), as represented by a Munsell symbol in accordance with JIS Z 8721, of not more than N2.5, wherein the black colorant-containing PTFE nanofiber (D) is obtained by subjecting a spinning solution containing at least PTFE or modified PTFE (A) to an electrospinning method. Thus, the present inventors have completed the present invention.

The above problem is solved by, for example, a black PTFE porous film which comprises a carbon-containing polytetrafluoroethylene (PTFE) nanofiber (d) and has a value (V), as represented by a Munsell symbol in accordance with JIS Z 8721, of not more than N2.5, wherein the carbon-containing PTFE nanofiber (d) is obtained by subjecting a spinning solution containing at least a powder of carbon (b) and PTFE or modified PTFE (A) to an electrospinning method.

In the present invention, subjecting a spinning solution containing PTFE or modified PTFE that is a binder resin to an electrospinning method plays an important role, and the PTFE porous film of the present invention is obtained by an electrospinning method. By incorporating a PTFE nanofiber having been colored with a black colorant, a PTFE porous film of a black color (value of not more than N2.5) having excellent properties (chemical resistance, heat resistance, electrical insulation properties, self-lubricating properties, non-adhesion properties, etc.) inherent in PTFE is obtained.

It is presumed that when the black colorant is, for example, carbon, subjecting a spinning solution containing PTFE or modified PTFE that is a binder resin and a carbon powder that is a colorant to an electrospinning method to produce a carbon-containing PTFE nanofiber plays an important role (even if PTFE that is a binder resin and carbon that is a colorant are kneaded and the kneadate is molded into a film by an extrusion method, a black PTFE porous film having the above value (V) of not more than N2.5 cannot be obtained, as shown by the later-described comparative example).

That is to say, the present invention is as follows.

The black PTFE porous film of the present invention is characterized in that the film comprises a black colorant-containing PTFE nanofiber (D) containing a polytetrafluorethylene (PTFE) nanofiber (E) and a black colorant (B), the film has a value (V), as represented by a Munsell symbol in accordance with JIS Z 8721, of not more than N2.5, and the black colorant-containing PTFE nanofiber (D) is obtained by subjecting a spinning solution containing at least PTFE or modified PTFE (A) to an electrospinning method.

In the black PTFE porous film of the present invention, it is preferable that the black colorant-containing polytetrafluoroethylene (PTFE) nanofiber (D) is a carbon-containing polytetrafluoroethylene (PTFE) nanofiber (d), the black colorant (B) is carbon (b), and the carbon-containing PTFE nanofiber (d) is obtained by subjecting a spinning solution containing at least PTFE or modified PTFE (A) and a powder of carbon (b) to an electrospinning method, from the viewpoint that the value (V) of the black PTFE porous film can be made smaller as compared with that in the past, and other viewpoints.

In the black PTFE porous film of the present invention, the amount of the black colorant (B) is preferably 3 to 20 parts by weight based on 100 parts by weight of the PTFE (A), from the viewpoint that the value (V) of the black PTFE porous film can be made smaller as compared with that in the past without impairing properties derived from PTFE or modified PTFE (A), and other viewpoints.

The filter of the present invention is characterized by having the above-mentioned black PTFE porous film.

When the black PTFE porous film is used as a filter, the filter may be the black PTFE porous film having a support, a protective film, etc., as long as properties required for a filter, such as air permeability and filtration performance, are not severely impaired.

The vent filter of the present invention is characterized by comprising the above-mentioned filter.

The production process for a black PTFE porous film of the present invention is characterized by comprising: dispersing at least polytetrafluoroethylene (PTFE) or modified PTFE (A), a powder of carbon (b) in an amount of 3 to 20 parts by weight based on 100 parts by weigh of the PTFE or modified PTFE (A) and a viscosity modifying polymer (C) in water and/or an organic solvent to prepare a spinning solution, subjecting the spinning solution to an electrospinning method to accumulate the resulting carbon-containing PTFE nanofibers (d) in the form of a sheet, and heating a sheet-like deposit of the carbon-containing PTFE nanofibers (d) to remove the water and/or the organic solvent and the viscosity modifying polymer (C) remaining in the sheet-like deposit.

### Advantageous Effects of Invention

The black PTFE porous film of the present invention is a black PTFE porous film which comprises a black colorant-containing PTFE nanofiber (D) containing a polytetrafluoroethylene (PTFE) nanofiber (E) and a black colorant (B) and has a value (V), as represented by a Munsell symbol in accordance with JIS Z 8721, of not more than N2.5, wherein the black colorant-containing PTFE nanofiber (D) is obtained by subjecting a spinning solution containing at least PTFE or modified PTFE (A) to an electrospinning method. Therefore, the value (V) of the black PTFE porous film, as represented by a Munsell symbol in accordance with JIS Z 8721, is not more than N2.5, and the film is excellent in blackness.

When the black colorant is, for example, carbon, the black PTFE porous film of the present invention is a black PTFE porous film comprising a carbon-containing PTFE nanofiber, wherein the carbon-containing PTFE nanofiber is obtained by subjecting a spinning solution containing a powder of carbon and polytetrafluoroethylene (PTFE) or modified PTFE (A) to an electrospinning method. Therefore, the value (V) of the black PTFE porous film, as represented by a Munsell symbol in accordance with JIS Z 8721, is not more than N2.5, and the film is excellent in blackness.

On that account, differently from a conventional PTFE porous film, the black PTFE porous film of the present invention can be preferably applied to uses in which a black color is required, such as a vent filter of a black cellular phone or a black speaker.

In the black PTFE porous film of the present invention, further, there is no need to add the black colorant such as a carbon powder in such a large amount as impairs performance of the PTFE porous film in order to enhance blackness, and therefore, the film is excellent also in air permeability, water repellency, tensile strength, etc. In particular, the black PTFE porous film obtained by subjecting a spinning solution containing the black colorant such as a carbon powder in an amount of 3 to 20 parts by weight based on 100 parts by weight of the PTFE to an electrospinning method or the black PTFE porous film in which spun PTFE nanofibers obtained by an electrospinning method have been colored with the black colorant such as a carbon powder in an amount of 3 to 20 parts by weight based on 100 parts by weight of the PTFE nanofibers are more excellent in the aforesaid blackness, air permeability, water repellency, tensile strength, etc.

On that account, such a black PTFE porous film can be also preferably applied to uses in which air permeability, water repellency, tensile strength, etc. are also required, such as filters, particularly a vent filter or the like.

The black PTFE porous film of the present invention can be very preferably applied particularly to uses in which not only a black color but also air permeability, water repellency, tensile strength, etc. are required, such as a vent filter of a black cellular phone, among the above uses.

According to the production process for a black PTFE porous film of the present invention, such a black PTFE porous film as above can be produced efficiently and with high productivity.

### BRIEF DESCRIPTION OF DRAWINGS

FIG. 1 is a view showing an example of an electrospinning apparatus and the principle of electrospinning.

FIG. 2 is a graph showing a relationship between the amount (part(s) by weight) of carbon (CB) based on 100 parts by weight of PTFE in a black PTFE porous film and the aforesaid value (V) of the black PTFE porous film of the present invention.

FIG. 3 is a graph showing a relationship between the amount (part(s) by weight) of carbon (CB) based on 100 parts by weight of PTFE and a Gurley value (sec/100 cc) based on a thickness 25 μm of the black PTFE porous film of the present invention.

FIG. 4 is a graph showing a relationship between the amount (part(s) by weight) of carbon (CB) based on 100 parts by weight of PTFE and a contact angle of the black PTFE porous film of the present invention.

### DESCRIPTION OF EMBODIMENTS

The best modes of the black PTFE porous film of the present invention, a production process for the same and uses of the same are described in detail hereinafter.

The amount of PTFE or modified PTFE and the amount of a black colorant such as carbon in the black PTFE porous film were treated as substantially the same as the amount of PTFE or modified PTFE and the amount of a black colorant such as a carbon powder, which had been used as raw materials in the production of the black PTFE porous film.

In the present specification, “blackness” is a term indicating that in the region between the aforesaid value of N9.5 (white) and the aforesaid value of N1 (black), the color is within the black color range (the value is not more than N2.5) (high blackness) or the color is out of the black color range (the value is not more than N2.5) (low blackness). The expression “high blackness” indicates that a black color of the value of not more than N2.5 is exhibited. The expression “low blackness” indicates that a color (gray or white with the value of more than N2.5 but not more than N9.5) apart from a black color (the value of not more than N2.5) is exhibited.

1. Black PTFE Porous Film

The black polytetrafluoroethylene (PTFE) porous film of the present invention is characterized in that the film comprises a black colorant-containing PTFE nanofiber (D) containing a poplytetrafluoroethylene (PTFE) nanofiber (E) and a black colorant (B), the film has a value (V), as represented by a Munsell symbol in accordance with JIS Z 8721, of not more than N2.5, and the black colorant-containing PTFE nanofiber (D) is obtained by subjecting a spinning solution containing at least PTFE or modified PTFE (A) to an electrospinning method.

It is preferable that the black polytetrafluoroethylene (PTFE) porous film of the present invention comprises a carbon-containing polytetrafluoroethylene (PTFE) nanofiber (d) and has a value (V), as represented by a Munsell symbol in accordance with JIS Z 8721, of not more than N2.5, and the carbon-containing PTFE nanofiber (d) is obtained by subjecting a spinning solution containing a powder of carbon (b) and PTFE or modified PTFE (A) to an electrospinning method, from the viewpoint that the value (V) of the black PTFE porous film can be made smaller than that in the past, and other viewpoints.

The nonwoven porous film comprising nanofibers obtained by electrospinning PTFE or modified PTFE has extremely highly uniform fiber diameters of the nanofibers as compared with ePTFE in which fiber structures different in thickness, such as structures of fibrous part and knot part, are mixed, and therefore, the nonwoven porous film has superior filter performance such as air permeability. Further, such a porous film hardly undergoes shrinkage due to heating as compared with ePTFE, and therefore, it has an advantage that properties are hardly changed by a production process including heating such as a reflow step.

[Black PTFE Nanofiber (D)]

The black PTFE nanofiber (D) contained in the black PTFE porous film is obtained by subjecting a spinning solution containing at least PTFE or modified PTFE (A) to an electrospinning method.

(Carbon-Containing PTFE Nanofiber (D))

The black-containing PTFE nanofiber (D) contained in the black PTFE porous film is preferably a carbon-containing PTFE nanofiber (d) from the viewpoint that the value (V) of the black PTFE porous film can be made smaller than that in the past, and other viewpoints.

The carbon-containing PTFE nanofiber (d) can be obtained by, for example, subjecting a spinning solution containing at least a powder of carbon (b) and PTFE or modified PTFE (A) to an electrospinning method.

[PTFE or Modified PTFE (A)]

In the present specification, the modified PTFE is obtained by copolymerizing a homopolymer of tetrafluoroethylene and a small amount (e.g., not more than 0.5% by mol) of another monomer.

The PTFE or the modified PTFE is preferably contained in an amount of 80 to 97 parts by weight in 100 parts by weight of the porous film from the viewpoint that properties of a PTFE resin imparted to the black PTFE porous film are intended to be impaired to the least.

[Black Colorant (B)]

The colorant to color the PTFE or the modified PTFE may be a colorant other than a black colorant, but from the viewpoints of practical use, etc., a black colorant is used.

The black colorant (B) is not specifically restricted as long as it is a material capable of coloring/dying the PTFE nanofiber to not more than N2.5, and examples of such materials include inorganic pigments, such as carbon, iron oxide and a metal complex compound, and organic dyes, such as an azine-based compound.

Of these black colorants, the inorganic pigments are preferable from the viewpoint that they are united with the PFEE nanofiber and thereby hardly fall off from the PTFE fiber and that a black color of the black PTFE nanofiber can be maintained over a long period of time. Particularly preferable is carbon from the viewpoint that it can efficiently color the PTFE nanofiber black.

These black colorants (B) can be compounded singly or as a mixture of two or more kinds in the black PTFE nanofiber.

Next, carbon in the case where a spinning solution containing PTFE or modified PTFE and a carbon powder is subjected to an electrospinning method to obtain a black PTFE porous film, said case being a particularly preferred embodiment, is described in detail.

When the black colorant is a carbon powder, coloring of not only the carbon-containing PTFE nanofiber but also the PTFE-based porous film black with a smaller value becomes possible.

(Carbon (b))

In the present specification, carbon in the case where a spinning solution containing a powder of carbon and PTFE or modified PTFE is subjected to an electrospinning method to obtain a black PTFE porous film is a component derived from a powder of carbon (b) that is present in the spinning solution subjected to an electrospinning method or that is used for coloring the spun PTFE or modified PTFE nanofiber.

Carbon is preferably a component derived from a carbon powder (powder of carbon) having a value (V), as represented by a Munsell symbol in accordance with JIS Z 8721, of not more than N2.5, preferably N2.0 to 1, from the viewpoint that not only the carbon-containing PTFE nanofiber but also the PTFE porous film is colored black in such a manner that the value (V), as represented by a Munsell symbol in accordance with JIS Z 8721, becomes not more than N2.5.

Since the black PTFE porous film of the present invention contains a PTFE nanofiber having been colored black with carbon, the film has been colored black.

The carbon is a component derived from a carbon powder, such as carbon black, graphite, carbon nanotube, carbon nanofiber or fullerene. From the viewpoint that not only the carbon-containing PTFE nanofiber but also the PTFE porous film is inexpensively colored black, and other viewpoints, the carbon is preferably a component derived from carbon black among the above carbons.

These carbons may be compounded singly or as a mixture of two or more kinds in the carbon-containing PTFE nanofiber.

The amount of the black colorant such as carbon is preferably not less than 3 parts by weight based on 100 parts by weight of the PTFE from the viewpoint that not only the PTFE nanofiber but also the PTFE-based porous film is colored black while minimizing impairment of performance of the PTFE resin, and particularly from the viewpoint of various properties of the film, the black colorant is preferably contained in an amount of 3 to 20 parts by weight based on 100 parts by weight of the PTFE in the black PTFE porous film. As described later, the amount of the black colorant such as carbon can be controlled by the amount of the black colorant such as carbon in the spinning solution subjected to an electrospinning method or the amount of the black colorant such as carbon that is used when the spun PTFE or modified PTFE nanofiber is colored.

The black colorant plays also a role of a filler. For example in case of carbon, the amount of carbon based on 100 parts by weight of the PTFE or the modified PTFE has influence on a mean fiber diameter of the carbon-containing PTFE nanofibers, and a thickness, a basis weight, a void, a pore diameter and air permeability of the black PTFE porous film, and has influence also on appearance such as blackness, water repellency, tensile strength, etc. of the carbon-containing PTFE nanofiber and the black PTFE porous film. From those influence, it is presumed to be that the carbon plays a role of not only a colorant but also a filler in the present invention.

On that account, a more preferred amount of the black colorant such as carbon based on 100 parts by weight of the PTFE or the modified PTFE depends upon desired properties of the black colorant-containing PTFE nanofiber such as a carbon-containing PTFE nanofiber and the black PTFE porous film, etc. This will be described in detail in the later-described working examples making reference to data.

The black colorant-containing PTFE nanofiber such as a carbon-containing PTFE nanofiber may contain other fillers and other fluororesin materials as long as they do not impair the object of the present invention. However, from the viewpoint that the PTFE nanofiber is colored black to obtain a black PTFE porous film while minimizing impairment of performance of the PTFE resin, it is preferable that in the black colorant-containing PTFE nanofiber such as a carbon-containing PTFE nanofiber, only the PTFE or the modified PTFE and the black colorant such as carbon are contained in the aforesaid quantity ratio after the later-described heat treatment.

1-2. Properties of Black PTFE Porous Film

Properties of the black PTFE porous film of the present invention are described hereinafter, and the measuring methods for various items and the evaluation methods therefor have only to be carried out in accordance with the measuring methods and the evaluation methods described in the later-described working examples.

[Blackness]

Blackness of the black PTFE porous film of the present invention is evaluated by a value (V) as represented by a Munsell symbol in accordance with JIS Z 8721, and the value (V) of the black PTFE porous film of the present invention is usually not more than N2.5, preferably not more than 1.8, particularly preferably not more than 1.3, and the lower limit thereof is 1.0 in any case (Table 2).

The blackness (the above value (V)) of the black PTFE porous film of the present invention can be adjusted to the above range by, for example, controlling the amount of the black colorant such as carbon based on the PTFE or the modified PTFE. The amount of the black colorant (in the state of being in the black PTFE porous film) such as carbon based on the PTFE or the modified PTFE in the black PTFE porous film is substantially equal to the amount of the black colorant (in the state of a raw material) such as a carbon powder based on the PTFE or the modified PTFE in the electrospinning solution. Hence, adjustment of the amount of the black colorant such as carbon based on the PTFE or the modified PTFE in the black PTFE porous film has only to be carried out by controlling the amount of the black colorant such as a carbon powder based on the PTFE or the modified PTFE in the electrospinning solution or the amount of the black colorant such as a carbon powder based on the electrospun PTFE nanofiber (the same shall apply hereinafter).

The value (V) of the black PTFE porous film of the present invention is not more than N2.5, and the film of the present invention has high blackness differently from a conventional expanded PTFE porous film having the above value (V) of at smallest N5.5. Therefore, the film of the present invention can be preferably applied to uses in which blackness is required, such as a vent filter for a black cellular phone.

In the present invention, a color having the above value (V) of not more than N2.5 is referred to as black, a color having the above value (V) of more than N2.5 but less than N8 is referred to as gray, and a color having the above value (V) of N8 to N10 is referred to as white.

The value (V) is applied not only to the black colorant-containing PTFE nanofiber such as a carbon-containing PTFE nanofiber but also to other materials.

In the case of an achromatic color (color having no hue, such as white, gray or black), the value (V) as represented by a Munsell symbol in accordance with JIS Z 8721 is expressed by N (symbol representing achromatic color) and a numerical value (lightness of color, i.e., value), such as “N2.5”, and differently from a case of a chromatic color (color having hue, such as red, blue or yellow), hue and saturation are not represented.

The value exhibits lightness of a color, and is usually determined by comparing a color of an evaluation object with a color of a color sample. Here, according to the physical definition, white that totally reflects light is white of the highest value (i.e., N10), and black that totally absorbs light is black of the lowest value (i.e., N0), but realization of such white and black are impossible in the actual color chart (color sample) or the like, and therefore, in usual, a value of N9.5 is used for white of the highest value, and a value of 1 is used for black of the lowest value.

It is presumed that on the surface of the black colorant-containing PTFE nonofiber such as a carbon-containing nanofiber, a black colorant such as carbon black can be selectively exposed, so that such a nanofiber can exhibit higher blackness as compared with carbon-containing e-PTFE (Comparative Example 1 described later). Further, when the black colorant-containing PTFE nanofiber such as a carbon-containing nanofiber is a substance obtained by subjecting a spinning solution containing PTFE or modified PTFE and containing, a carbon powder to an electrospinning method, such a nanofiber has advantages of no carbon powder drop (no staining with carbon), no detachment and no discoloration in comparison with carbon supported on the nanofiber by aftertreatment.

[Mean Fiber Diameter]

The mean fiber diameter of the black colorant-containing PTFE nanofibers such as carbon-containing PTFE nanofibers is preferably 400 to 3000 nm, more preferably 400 to 1500 nm, still more preferably 400 to 1000 nm, from the viewpoint that excellent air permeability, water repellency, etc. are imparted to the black PTFE porous film.

[Thickness]

The thickness of the black PTFE porous film of the present invention is preferably not less than 10 μm, more preferably 30 to 300 μm, from the viewpoints of tensile strength, air permeability, etc. of the porous film.

[Mean Flow Diameter]

The mean flow diameter of the black PTFE-based porous film of the present invention (measuring method: bubble point method) is preferably 0.5 to 5.0 μm, more preferably 1.0 to 3.0 μm, still more preferably 1.0 to 2.0 μm, from the viewpoint that excellent air permeability is imparted.

[Air Permeability]

Air permeability of the black PTFE-based porous film of the present invention is evaluated by a mean Gurley value.

The mean Gurley value of the black PTFE-based porous film of the present invention, as measured in accordance with JIS P8117, is determined as a 25 μm equivalent air permeability (sec/100 cc) that is obtained by multiplying an air permeability (sec/100 cc) by 25 (μm)/film thickness (μm). From the viewpoint that excellent air permeability is imparted to the black PTFE-based porous film, the 25 μm equivalent air permeability is preferably 0.3 to 10.0 s/100 cc, more preferably 0.3 to 3.0 s/100 cc, particularly preferably 0.3 to 2.0 s/100 cc.

[Water Repellency]

Water repellency of the black PTFE porous film of the present invention is evaluated by a water contact angle.

The water contact angle of the black PTFE porous film of the present invention is preferably 110 to 150°, more preferably 130 to 150°, from the viewpoint that excellent water repellency is imparted to the black PTFE porous film.

When the water contact angle is in the above range, the black PTFE porous film of the present invention is excellent in water repellency, and therefore, it can be preferably applied to uses in which water repellency is required, such as a vent filter of a cellular phone, etc.

[Tensile Strength]

Tensile strength of the black PTFE porous film of the present invention is preferably 0.3 to 20 N/mm², more preferably 0.5 to 10 N/mm², still more preferably 1.2 to 1.7 N/mm².

When the tensile strength is in the above range, the black PTFE porous film of the present invention is not easily broken even if it is used for a filter or the like.

2. Production Process for Black PTFE Porous Film

The black PTFE porous film of the present invention can be produced by, for example, performing an electrospinning method (electrospinning method) using, as raw materials, PTFE or modified PTFE and a black colorant such as a carbon powder to form (or prepare) black colorant-containing PTFE nanofibers such as carbon-containing PTFE nanofibers and then heat-treating the resulting black colorant-containing PTFE nanofibers such as carbon-containing PTFE nanofibers under the specific conditions.

In the spinning solution, at least PTFE or modified PTFE has only to be contained, but hereinafter, a case where the black colorant is carbon and a spinning solution containing at least a powder of carbon and PTFE or modified PTFE is subjected to an electrospinning method is sequentially described.

The following production process can be applied to also a case where the black colorant is a substance other than a carbon powder.

Further, an embodiment in which PTFE particles or modified PTFE particles and a carbon powder are added in the form of a dispersion of the particles and the carbon powder in water and/or an organic solvent may be modified into an embodiment in which particles having been previously obtained by uniting (coloring) PTFE particles or modified PTFE particles with a carbon powder are added in the form of a dispersion of the particles in water and/or an organic solvent, and such a modified embodiment is also applicable.

2-1. Preparation of Spinning Solution

First, a spinning solution to be subjected to electrospinning (electrospinning) is prepared.

The spinning solution is prepared by adding PTFE or modified PTFE and a carbon powder to water and/or an organic solvent (e.g., chloroform, methanol, formic acid, N,N-dimethylformamide, tetrahydrofuran, 1,2-dichloroethane, ethyl acetate, methyl ethyl ketone or the like) and then, if necessary, further adding a viscosity modifying polymer (C).

The viscosity modifying polymer (C) is used in the electrospinning of a material that is insoluble in a solvent, such as PTFE, and is used in order to adjust the viscosity of the spinning solution to a desired range and thereby to form a desired carbon-containing PTFE nanofiber. In the subsequent heat treatment, the viscosity modifying polymer is removed. Examples of the viscosity modifying polymers (C) include polyethylene oxide, dextran, alginic acid, chitosan, starch, polyvinylpyridine compound, cellulose compound, cellulose ether, hydrolyzed polyacrylamide, polyacrylate, polycarboxylic acid salt, polyvinyl alcohol, polyethylene glycol, polyethyleneimine, polyvinylpyrrolidone, polyacrylic acid, polymethacrylic acid and polyitaconic acid.

Examples of the solvents include water, chloroform, methanol, formic acid, N,N-dimethylformamide, tetrahydrofuran, 1,2-dichloroethane, ethyl acetate and methyl ethyl ketone. Of these, water is preferable as a medium for dispersing PTFE, carbon, etc. from the viewpoints of reduction of environmental burden, reduction of cost, ease of handling, volatility of a medium in the electrospinning, etc.

In the preparation of the spinning solution, PTFE or modified PTFE and a carbon powder may be added in any form to the spinning solution as long as the spinning solution can be prepared. From the viewpoint that they are homogeneously dispersed to make desired spinning possible, and other viewpoints, it is preferable to add them in the form of a dispersion in which they are dispersed in water and/or an organic solvent. Further, in order to control adhesion of the PTFE or the modified PTFE particles and the carbon powder to each other, the above dispersion may be subjected to stirring treatment, heating/cooling treatment, charge (pH) control treatment, etc.

In the dispersion of the carbon powder, the mean secondary particle diameter of the carbon powder is preferably 50 to 1000 nm, more preferably 80 to 550 nm, still more preferably 80 to 280 nm, from the viewpoint that the PTFE nanofibers and carbon are united together without greatly increasing the fiber diameters of the nonofibers and besides not only the carbon-containing PTFE nanofibers but also the porous film is colored black while minimizing impairment of performance of the PTFE resin, and other viewpoints.

In the present specification, the mean secondary particle diameter indicates a mean diameter of secondary particles that are agglomerates of primary particles (undividable minimum particles) that are single particles, and is observed as an actually measured particle diameter in the dispersion or the like. The mean primary particle diameter of the carbon powder is preferably 1 to 100 nm, more preferably 5 to 80 nm, still more preferably 8 to 20 nm, from the viewpoint that the PTFE nanofibers are efficiently colored black, and other viewpoints.

The ratio of the size of the primary particle of the carbon powder to the size of the primary particle of the PTFE particle is preferably 1/5 to 1/50, more preferably 1/10 to 1/20, from the above-mentioned viewpoint.

The mean secondary particle diameter is measured by laser diffractometry.

The mean primary particle diameter of the PTFE particles is preferably 10 to 500 nm, more preferably 30 to 400 nm, still more preferably 50 to 300 nm.

The content of the carbon powder in the dispersion is more preferably 1 to 20 parts by weight, preferably not more than 30 parts by weight, still more preferably 3 to 20 parts by weight, from the viewpoints of viscosity of the spinning solution, fiber diameter of the carbon-containing PTFE nanofiber, tensile strength, etc.

Examples of dispersions of a carbon powder that are on the market include Aqua-Black 162 (hydrophilic carbon black, manufactured by Tokai Carbon Co., Ltd., mean secondary particle diameter: 110 nm, carbon black concentration: 20% by weight) and Aqua-Black 001.

The PTFE or the modified PTFE may be one having been produced in accordance with a conventional process, or may be a commercially available one.

A commercially available dispersion of PTFE or modified PTFE is, for example, D210-C (manufactured by Daikin Industries, Ltd., PTFE content: 60% by weight, mean particle diameter: 230 nm).

Since the viscosity of the spinning solution has influence on the shape and the properties (e.g., fiber diameter, tensile strength, etc.) of the resulting carbon-containing PTFE-based nanofiber, it is preferably 500 to 300000 mPa·s, more preferably 500 to 50000 mPa·s, particularly preferably 1000 to 30000 mPa·s.

The viscosity of the spinning solution has only to be adjusted to the above range by adding a viscosity modifier in an appropriate amount to the spinning solution. When the viscosity of the spinning solution is higher than the upper limit of the above range, the viscosity has only to be adjusted to the above range by, for example, adding water and/or an organic solvent to the spinning solution.

2-2. Electrospinning (Electrospinning)

The spinning solution prepared as above is fed to an electrospinning apparatus, and then electrospinning is carried out.

The electrospinning can be carried out in accordance with, for example, the method described in U.S. Unexamined Patent Application Publication No. 2010-0193999 A1.

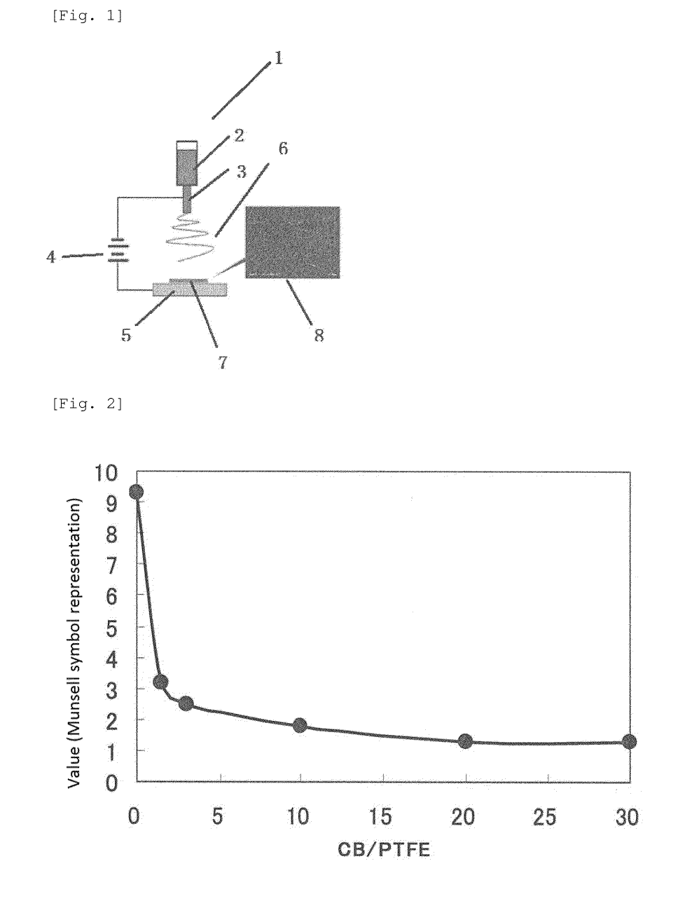

Here, FIG. 1 is taken up as an example of the electrospinning method, and referring to this, an outline of the electrospinning method is described.

In an electrospinning apparatus 1, a container 2 storing a spinning solution therein and a target electrode connected to a direct current voltage power source 4 are provided. At the tip (lower end) of the container 2, a spinneret 3 capable of discharging a spinning solution is provided. Here, if the spinning solution is discharged from the spinneret 3 while applying a high voltage between the spinneret 3 and a collector 5, PTFE, carbon and the like are electrostatically charged when the spinning solution passes through the spinneret 3. While the spinning solution moves from the spinneret 3 to the collector 5 (provided below the spinneret), fibers (nanofibers 6) are formed along a line of electric force, and the nanofibers 6 are accumulated on the collector 5 to forma nonwoven fabric 7 of the nanofibers (see also electron micrograph 8 of the nonwoven fabric of nanofibers).

As the collector 5, a collector of sheet type, drum type, moving belt type or the like can be mentioned. Examples of materials to form the collector 5 include metals such as iron, aluminum and copper. The type and the material species of the collector 5 are not specifically restricted as long as the electrospinning can be carried out, and it is enough just to select them according to the purpose. In order to enhance spinning efficiency, a spinning solution heating mechanism is provided in the spinneret 3, when needed.

By feeding the spinning solution to such an electrospinning apparatus (e.g., ES-2300, manufactured by HUENS Co., Ltd.) and carrying out electrospinning, carbon-containing PTFE nanofibers are produced by spinning. The spun carbon-containing PTFE nanofibers are usually accumulated on the collector having been installed in advance, and a sheet-like deposit composed of the carbon-containing PTFE nanofibers is formed.

2-3. Heat Treatment

When the sheet-like deposit of the carbon-containing PTFE nanofibers obtained as above is subjected to heat treatment in the following manner, a black PTFE porous film of the present invention can be obtained.

The heat treatment is usually carried out by heat-treating the sheet-like deposit of the carbon-containing PTFE nanofibers (D) under the conditions of 200 to 390° C. and 30 to 300 minutes.

In an electric furnace such as DRH453WA (manufactured by Advantec Toyo Kaisha, Ltd.), the sheet-like deposit of the carbon-containing PTFE nanofibers is heated up to 200 to about 390° C. from room temperature (usually about 25° C.) at a heating rate of 1 to 10° C./min, and when a temperature of 200 to about 390° C. is reached, the deposit is maintained at that temperature for 30 to 300 minutes.

However, it is preferable to control the heat treatment in such a manner that the heating time at 200 to 390° C. becomes not longer than 300 minutes in total.

By this heat treatment, the water and/or the organic solvent and the viscosity modifying polymer remaining in the sheet-like deposit are removed.

Thus, a PTFE porous film (PTFE nonwoven fabric) containing carbon-containing PTFE nanofibers can be produced.

### EXAMPLES

Next, the present invention is described in more detail with reference to the following examples, but it should be construed that the present invention is in no way limited to those examples.

### Example 1

To 45 parts by weight of a PTFE dispersion, 4.2 parts by weight of a hydrophilic carbon black dispersion and 2.3 parts by weight of polyethylene oxide were added, to prepare a spinning solution. The resulting spinning solution was fed to an electrospinning apparatus (ES-2300, manufactured by HUENS Co., Ltd.), and electrospinning was carried out under the conditions described in the following Table 1 to accumulate electrospun carbon black-containing PTFE nanofibers of a black color, whereby a sheet-like deposit was obtained.

Details of the raw materials are as follows.
PTFE dispersion: product number D210-C, manufactured by Daikin Industries, Ltd., PTFE content: 60% by weight, mean primary particle diameter: 220 nm (catalog value)
Hydrophilic carbon black dispersion: product name Aqua-Black 162, manufactured by Tokai Carbon Co., Ltd., mean secondary particle diameter: 110 nm (catalog value), carbon black (CB) concentration: 20% by weight
Polyethylene oxide (PEO): manufactured by SIGMA-ALDRICH Co., molecular weight: 300000

TABLE 1

| | | | | Distance | | |
|---|---|---|---|---|---|---|
| | | Feeding | Temper- | between | | Inner |
| | Spin- | pressure | ature | spinneret | Type | diameter |
| Applied | ning | for | of | and | of | of |
| voltage | time | sample | sample | collector | spinneret | syringe |
| 25 kV | 30 min | 0.004 | 25° C. | 20 cm | 18 G | 23 mm |
| | | MPa | | | | |

Subsequently, the resulting deposit of the carbon black-containing PTFE nanofibers was fed to an electric furnace (DRH453WA, manufactured by Advantec Toyo Kaisha, Ltd.), heated up to 360° C. from room temperature at a heating rate of 2° C./min and maintained at 360° C. for 30 minutes to produce a black PTFE porous film formed of a carbon black-containing PTFE nanofiber nonwoven fabric. The resulting black PTFE porous film was subjected to the following evaluation, and various evaluation results are set forth in Table 2.

In the calculation of the amount (part (s) by weight) of CB based on 100 parts by weight of PTFE in Table 2, the amount of PTFE and the amount of a carbon powder in the spinning solution were taken as equal to the amount of PTFE and the amount of a carbon powder in the resulting porous PTFE film. The amount of CB was determined by the formula: (amount of hydrophilic carbon black dispersion×concentration (% by weight) of carbon black in the hydrophilic carbon black dispersion)/100, and the amount of PTFE was determined by the formula: (amount of PTFE dispersion×concentration (% by weight) of PTFE in the PTFE dispersion)/100.

(1) Measurement of Viscosity of Spinning Solution

Viscosity measurement was carried out at 25° C. utilizing a viscometer (TVB-10H) manufactured by Toki Sangyo Co., Ltd. and a small sample adaptor.

(2) Measurement of Value of PTFE Porous Film

Measurement of a value (Munsell symbol representation) of the PTFE porous film was carried out using a colorimeter (CR-400) manufactured by Konica Minolta, Inc.

(3) Observation of Appearance of PTFE Porous Film

A photograph of the PTFE porous film was taken by a digital camera, and appearance and color of the PTFE porous film were evaluated.

(4) Mean Fiber Diameter of PTFE Nanofibers

From the PTFE porous film that would become a measuring object, a region for SEM observation was selected at random, then this region was subjected to SEM observation (magnifications: 10,000) using a scanning electron microscope (S-3400N) manufactured by Hitachi High Technologies Corporation, and 10 PTFE nanofibers were selected at random. Then, the sections of these nanofibers were observed, and a mean value of the fiber diameters was calculated. The resulting value was taken as a mean fiber diameter.

(5) Thickness

Using a high-precision digital length measuring machine (LITEMATIC VL-50) manufactured by Mitutoyo Corporation, measurement of a film thickness was carried out under the conditions of a measuring force of 0.01N.

(6) Porosity

Porosity was calculated from the following formula using a measured thickness, a basis weight and a specific gravity of each material used.

Porosity (%)={1-basis weight (g/m²)/specific gravity (g/cm²)/thickness (mm)/1000)}×100

(7) Mean Flow Diameter of PTFE Porous Film

Measurement was carried out by a bubble point method using a perm porometer (CFP-1200-AEL porous material automatic pore diameter distribution measuring system) manufactured by Porous Materials Inc. in accordance with ASTM F316-86.

With regard to air permeability, evaluation measurement was carried out in accordance with JIS P-8187, and an air permeability (sec/100 cc) was multiplied by 25 (μm)/film thickness (μm) to obtain a 25 μm equivalent air permeability (sec/100 cc).

(8) Water Repellency of PTFE Porous Film

For evaluation of water repellency, a water contact angle was measured in accordance with JIS R3257 using a contact angle meter (CA-X) manufactured by Kyowa Interface Science Co., Ltd., and a film surface of the PTFE porous film was evaluated.

(9) Tensile Strength of PTFE Porous Film

Measurement of tensile strength and evaluation thereof were carried out in accordance with JIS K7161 using a tensile tester (EZ-TEST) manufactured by Shimadzu Corporation.

### Examples 2 to 3, Comparative Examples 1 to 3

PTFE porous films were produced in the same manner as in Example 1, except that the amounts of the PTFE dispersion, the CB dispersion and PEO were changed as described in Table 2. Then, the PTFE porous films were subjected to various measurements.

The results are set forth in Table 2.

### Reference Example 1

A gray ePTFE film having a thickness of 32 μm and a porosity of 80%, which had been obtained by adding 1.5 wt % of carbon black to a PTFE fine powder, mixing them, then mixing the resulting mixture with a liquid lubricating agent, carrying out preforming, then subjecting the resulting preform to paste extrusion to form a tape and biaxially orienting the tape to make it porous, was subjected to various measurements.

Next, the above examples and comparative examples are discussed, but the matters that can be understood from the above results are not limited to the following.

[Appearance Observation, Blackness]

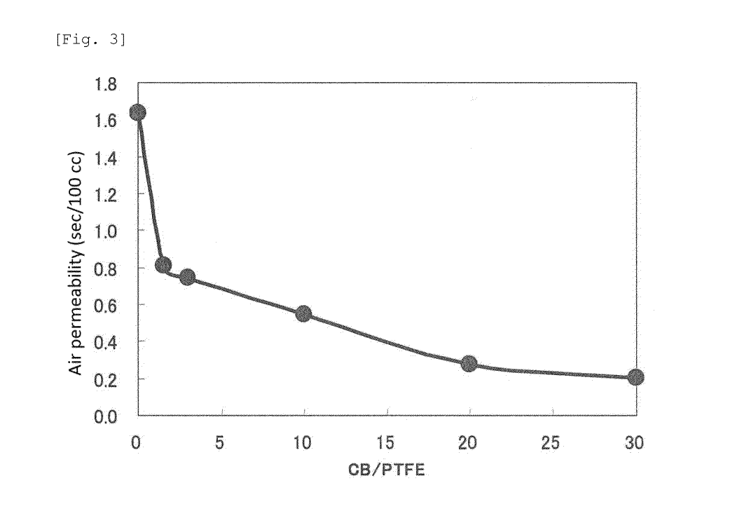

As can be seen from FIG. 2, by increasing the amount of carbon black (CB) based on the amount of PTFE (that is, by increasing the amount (part (s) by weight) of CB based on 100 parts by weight of PTFE), blackening of the CB-containing PTFE nanofibers proceeded, and blackening of the PTFE porous film also proceeded. The CB-non-containing PTFE nanofibers (0 part by weight of CB based on 100 parts by weight of PTFE) were white, and the CB-containing PTFE nanofibers containing 1.5 parts by weight of CB based on 100 parts by weight of PTFE were gray with a value of 3.2. It has been confirmed that the CB-containing PTFE nanofibers containing not less than 3.0 parts by weight of carbon (CB) based on 100 parts by weight of PTFE were black (value of not more than N2.5)

In the case where the PTFE porous film was produced not by forming the CB-containing PTFE nanofibers obtained by an electrospinning method into a sheet but by the extrusion/rolling method, the amount (part(s) by weight) of CB based on 100 parts by weight of PTFE was 1.5 parts by weight, and the PTFE porous film was gray with a value of 5.5.

[Mean Fiber Diameter of CB-Containing PTFE Nanofibers]

It has been confirmed that when the amount (part (s) by weight) of CB based on 100 parts by weight of PTFE was 0 to 10 parts by weight, the mean fiber diameter of the CB-containing PTFE nanofibers hardly varied, and when the amount (part(s) by weight) of CB based on 100 parts by weight of PTFE was not less than 20 parts by weight, the mean fiber diameter of the CB-containing PTFE nanofibers became smaller. The reason is presumed to be that electrical conductivity of the spinning solution was enhanced by the addition of CB to the spinning solution, and thereby, formation of thinner nanofibers due to the electrospinning method became possible. Further, it is thought that the size of the CB primary particle is extremely smaller as compared with the size of the PTFE primary particle (the ratio of the particle diameter of the CB primary particle to the particle diameter of the PTFE primary particle is thought to be about 1/10 to 1/20), and it is presumed that when the PTFE particles and the CB particles were subjected to an electrospinning method, penetration of apart of the CB particles into gaps among the PTFE particles for forming the PTFE nanofibers became possible, so that the fiber diameters of the CB-containing PTFE nanofibers did not greatly increased.

[Air Permeability of PTFE Porous Film]

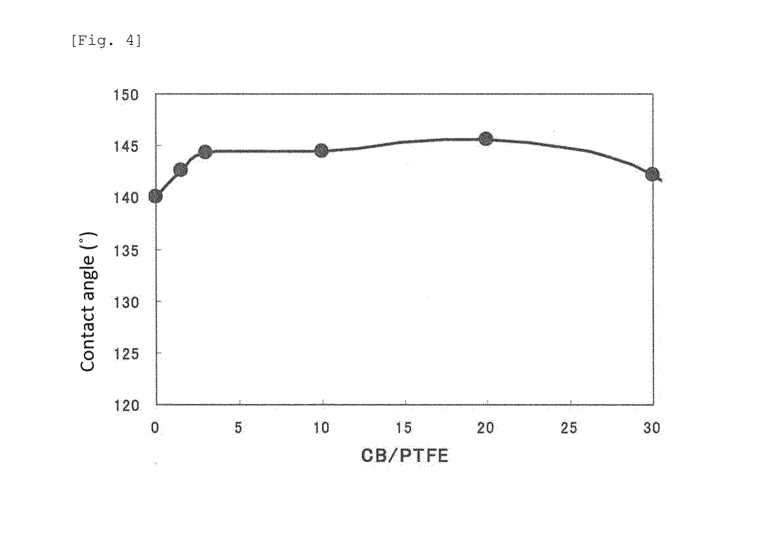

In FIG. 3, the amount (part(s) by weight) of CB based on 100 parts by weight of PTFE and the evaluation result of air permeability of the PTFE porous film are shown.

As can be seen from FIG. 3, air permeability is enhanced with increase of the amount (part(s) by weight) of CB based on 100 parts by weight of PTFE. This can be evaluated to be attributable to increase in porosity and thinning of fibers that are due to increase in the amount of CB in the PTFE porous film.

[Water Repellency of PTFE Porous Film]

In FIG. 4, the amount (part(s) by weight) of CB based on 100 parts by weight of PTFE and a change in the contact angle of the PTFE porous film are shown.

When the amount (part(s) by weight) of CB based on 100 parts by weight of PTFE was in the range of 3 to 20 parts by weight, the PTFE porous film exhibited a higher contact angle of about 144 to 145° than the CB-non-containing PTFE porous film. It is considered from this that water repellency was enhanced by virtue of increase in porosity and thinning of fibers.

[Tensile Strength]

When the amount (part(s) by weight) of CB based on 100 parts by weight of PTFE was up to 20 parts by weight, the PTFE porous film exhibited a tensile strength nearly equal to or superior to that of the PTFE porous film composed of the CB-non-containing PTFE nanofibers. However, in the case of the black PTFE porous film containing 30 parts by weight of CB based on 100 parts by weight of PTFE, the tensile strength was greatly lowered.

### INDUSTRIAL APPLICABILITY

The black PTFE porous film of the present invention is black while keeping excellent water repellency, heat resistance, chemical resistance, air permeability, tensile strength, etc. that are derived from PTFE, and therefore, it can be preferably used for a filter (particularly filter requiring black color), such as a vent filter.

### REFERENCE SIGNS LIST

1: electrospinning apparatus
2: container storing spinning solution
3: spinneret
4: direct current voltage power source
5: collector
6: nanofiber
7: nanofiber deposit
8: electron micrograph of nanofiber nonwoven fabric

1. A black PTFE porous film comprising:
a black colorant-containing PTFE nanofiber (D) containing a polytetrafluoroethylene (PTFE) nanofiber (E) and a black colorant (B), and
having a value (V), as represented by a Munsell symbol in accordance with JIS Z 8721, of not more than N2.5,
wherein the black colorant-containing PTFE nanofiber (D) is obtained by subjecting a spinning solution containing at least PTFE or modified PTFE (A) to an electrospinning method.

2. The black PTFE porous film as claimed in claim 1, wherein the black colorant-containing PTFE nanofiber (D) is a carbon-containing polytetrafluoroethylene (PTFE) nanofiber (d),
the black colorant (B) is carbon (b), and
the carbon-containing PTFE nanofiber (d) is obtained by subjecting a spinning solution containing at least a powder of carbon (b) and PTFE or modified PTFE (A) to an electrospinning method.

3. The black PTFE porous film as claimed in claim 1, wherein the amount of the black colorant (B) is 3 to 20 parts by weight based on 100 parts by weight of the PTFE or modified PTFE (A).

4. A filter having the black PTFE porous film as claimed in claim 1.

5. A vent filter comprising the filter as claimed in claim 4.

6. A production process for a black PTFE porous film, comprising:
dispersing polytetrafluoroethylene (PTFE) or modified PTFE (A), a powder of carbon (b) in an amount of 3 to 20 parts by weight based on 100 parts by weigh of the PTFE or modified PTFE (A) and a viscosity modifying polymer (C) in water and/or an organic solvent to prepare a spinning solution,
electrospinning the spinning solution, and
heating a sheet-like deposit of the resulting carbon-containing PTFE nanofibers (d) to remove the water and/or the organic solvent and the viscosity modifying polymer (C) remaining in the sheet-like deposit.

7. The black PTFE porous film as claimed in claim 2, wherein the amount of the black colorant (B) is 3 to 20 parts by weight based on 100 parts by weight of the PTFE or modified PTFE (A).

8. A filter having the black PTFE porous film as claimed in claim 2.

9. A filter having the black PTFE porous film as claimed in claim 3.
